(19) United States
(12) Patent Application Publication
(10) Pub. No.: US 2004/0145141 A1
(43) Pub. Date: Jul. 29, 2004

(54) VEHICLE HINGE ASSEMBLY

(75) Inventor: Warren E. Dennis, Santa Barbara, CA (US)

Correspondence Address: Milton M. Field, 2212 White Oaks Drive, Alexandria, VA, 22306, US

(73) Assignee: The Electric Transportation Company, LLC, Santa Barbara, CA

(21) Appl. No.: 10/349,088

(22) Filed: Jan. 23, 2003

(51) Int. Cl. B62M 1/00

(52) U.S. Cl. 280/87.05

(57) ABSTRACT

A vertical stem of a scooter has an upper stem portion hinged to a lower stem portion. A flat hinge plate is pivoted on the lower stem portion and is received in a slot at the lower end of the upper stem portion. A hinge cover sleeve has three positions: one maintaining the vehicle stem erect; a second permitting the upper stem portion to be folded to a horizontal position; and a third permitting the hinge assembly to be disassembled. The three positions are established by two detent buttons. The hinge cover sleeve may be threaded tightly onto a hinge base on the lower stem portion to eliminate rattles. When the hinge plate is slid into the slot, an alignment and stop pin projecting from the hinge plate maintains proper alignment of the hinge plate and limits the distance the hinge plate slides into the slot.

### 1. FIELD OF THE INVENTION

The present invention relates hinge assemblies, and more particularly to a foldable handlebar stem of a vehicle, such as a scooter.

### 2. DESCRIPTION OF THE PRIOR ART

It is known in the prior art that it is desirable to provide vehicles such as scooters and skateboards with easily foldable vertical elements. In U.S. Pat. No. 6,318,741, for example, a tenon and mortise hinge assembly may be lifted from a frame pipe by releasing a quick release connecter. Once lifted free of the frame pipe, it becomes possible to fold over the handle pipe. However, the hinge assembly, which requires that the flat tenon be mounted on a rivet, is not easily assembled and disassembled.

In U.S. Pat. No. 6,213,484, a sleeve, which normally covers the joint between an upper vertical element and a joint pin projecting upwardly from a board, may be raised by means of a strap to uncover the joint and permit folding the upper element to a horizontal position. Likewise in U.S. Pat. No. 6,347,681, a collar may be raised to expose the joint to permit folding the steering column to a “stowed” position. The joints in these patents, which do not employ a flat hinge plate, are also not readily assembled and disassembled.

Although the other patents, such as U.S. Pat. No. 628,897, U.S. Pat. No. 5,273,302, and U.S. Pat. No. 5,752,711 disclose the use of hinge assemblies in bicycles, these are not used to facilitate folding down the vertical stem and do not show hinges which are easily assembled and disassembled.

### SUMMARY OF THE INVENTION

It has been found to be desirable to provide a hinge assembly that is readily assembled and disassembled without the use of tools to facilitate compact packing of the disassembled parts in a shipping box.

It is also desirable to provide means for locking the hinge assembly in the vertical stem of a vehicle with a hinge cover sleeve which is tightened by engaging threads on a section of the stem to eliminate rattle and, even if there has been wear, by further tightening to still eliminate rattle.

By using detent buttons, the hinge cover sleeve is reliably positioned in one of three positions. In one position, the hinge cover sleeve covers the hinge assembly to keep the upper and lower stem portion erect and in alignment. In a second position, the hinge cover sleeve uncovers the hinge assembly to permit the upper stem section to fold downwardly to a substantially horizontal storage position, but still covers enough of the hinge plate to prevent the hinge plate from becoming disengaged from a hinge plate receiving slot. In the third position, the hinge cover sleeve completely uncovers the hinge assembly, permitting the hinge plate to be manually slid out of the receiving slot to disassemble the hinge means.

The hinge plate is pivoted on a pivot pin in a slot provided at the upper end of the lower stem portion. The lower end of the upper stem portion is formed with a hinge plate receiving slot. The hinge plate has a free edge that may be slid into the receiving slot. In order to properly align and position the hinge plate in the receiving slot, an alignment and stop pin projects from the free edge and rides along a guide wall provided in the slot to properly align the hinge plate. When the hinge plate has been inserted the proper amount, alignment and stop pin engages a stop wall provided in the receiving slot.

Opposing walls of the receiving slot are formed with guide grooves, and opposite sides of the hinge plate are formed with rail forming grooves, which form guide rails between the rail forming grooves and the free edge. When the hinge plate is inserted in the receiving slot, these guide rails are engaged in the guide proves to enhance smooth sliding of the hinge plate into the receiving slot for assembly and from the receiving slot for disassembly.

Other objects, features, and advantages of the invention will become apparent from the detailed description and drawings, in which:

### BRIEF DESCRIPTION OF THE DRAWINGS

FIG. 1 is a perspective view of an electric scooter incorporating a hinge assembly of the invention;

FIG. 2 is a side elevation view of the electric scooter of FIG. 1;

FIG. 3 is a side elevation view corresponding to the view of FIG. 2 with the upper portion of the handlebar stem folded to a substantially horizontal position;

FIG. 4 is a detailed partial view showing the hinge assembly of the invention with the hinge cover sleeve in its first position abutting the first detent button and covering the hinge means and threaded to the lower stem portion to keep the upper and lower stem position aligned.

FIG. 5 is a detailed partial view showing the hinge assembly with the hinge cover sleeve in its second position covering the first detent button and abutting the second detent button uncovering the hinge means to permit folding of the upper stem portion as shown in FIG. 6;

FIG. 6 is a detailed partial view showing the upper stem portion in its folded position;

FIG. 7 is a detailed partial view with the hinge cover sleeve in its third position covering both detent buttons and allowing the hinge plate pivoted to the lower stem portion to be separated from a hinge plate receiving slot on the upper stem portion as shown; and

FIG. 8 is a cross-sectional view showing the hinge plate reassembled with the hinge plate receiving slot.

### DETAILED DESCRIPTION

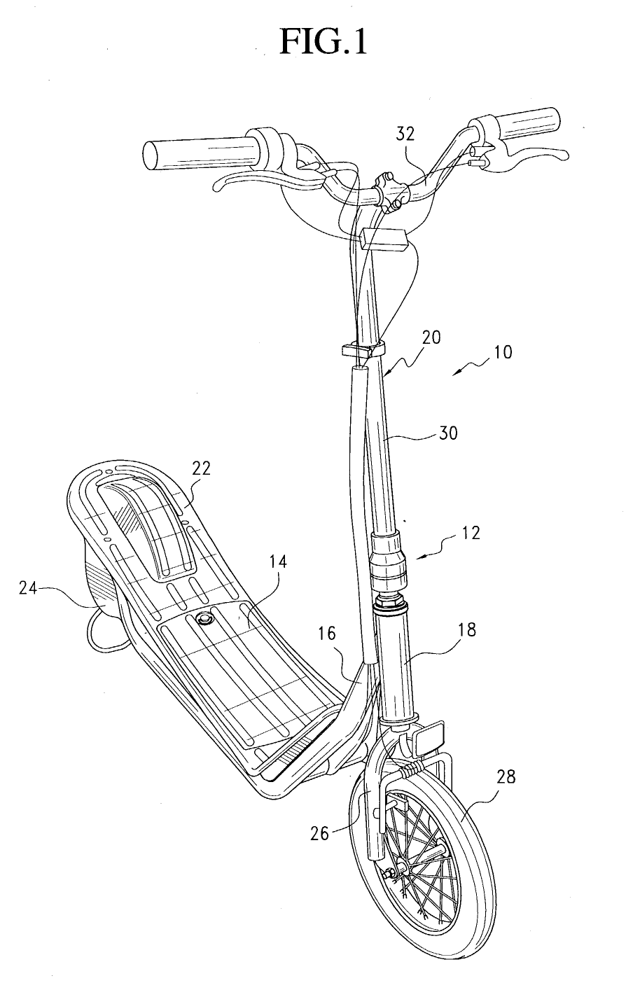

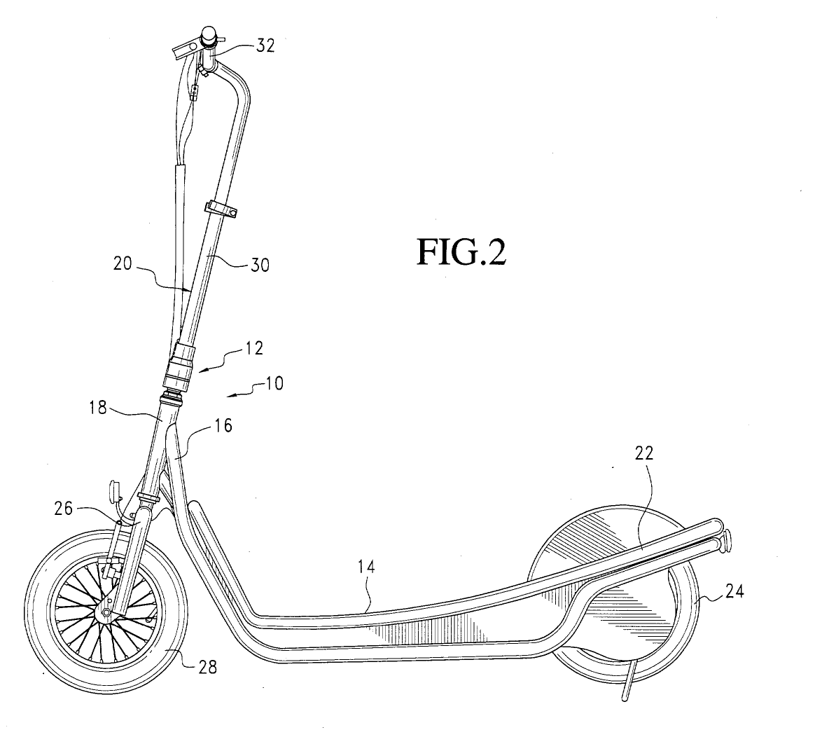

An electric scooter 10 incorporating a hinge assembly 12 of the invention is shown in FIGS. 1 and 2. Scooter 10 comprises a base 14 that, at its front end 16, is attached to a lower portion 18 of a vertical hollow handlebar stem 20 and, at its rear end 22, is mounted on a rear wheel 24. Lower portion 18 of vertical stem 20 is mounted on a wheel yoke 26 that supports front wheel 28. Hinge assembly 12 connects lower portion 18 of vertical stem 20 to an upper portion 30 of vertical stem 20. In turn, upper portion 30 supports handlebar 32.

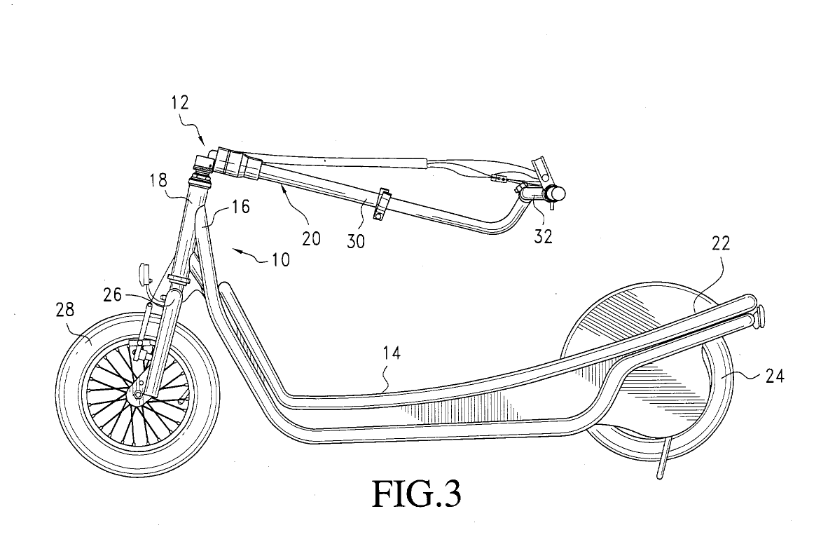

As shown in FIG. 3, and as explained more fully below, hinge assembly 12 may be adjusted to permit upper stem portion 30 to be folded to a substantially horizontal position. With upper portion 30 so folded, scooter 10 is made more compact and is suitable for storage.

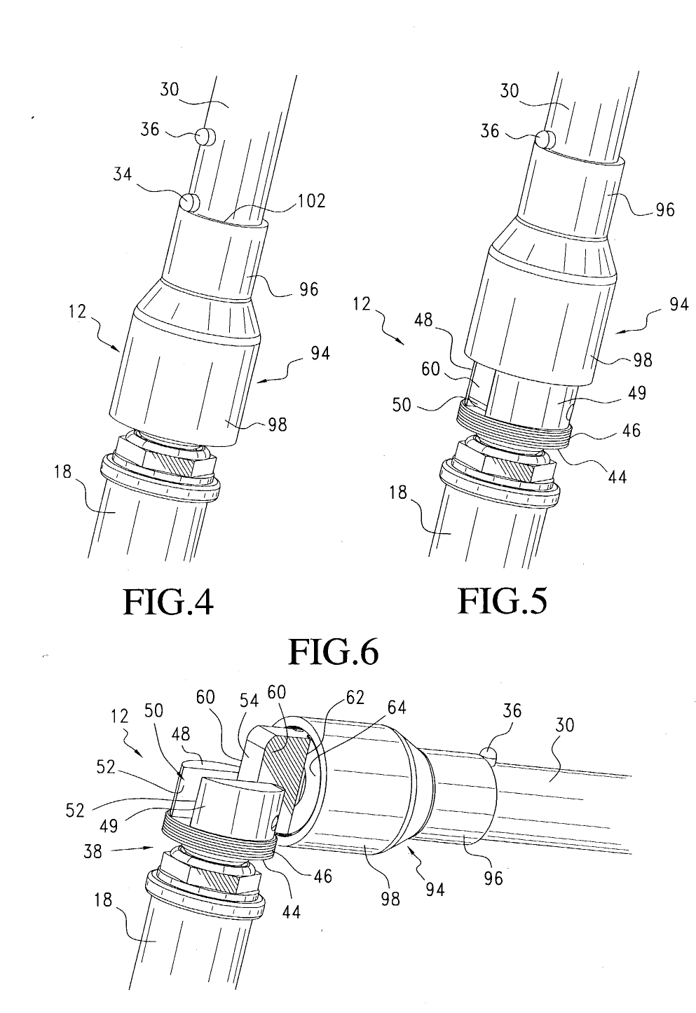

Turning to FIG. 4, upper stem portion 30 is provided with a pair of retractable stop abutments 34 and 36, one above the other. These stop abutments are detent buttons which are spring-biased to a projected position, but which may be depressed to a retracted position.

Hinge means 12 includes a hinge plate support member 38 mounted at the upper end of lower stem portion 18. As seen in FIGS. 6, 7, and 8, support member 38 comprises a support stem 40 which is mounted on a support plate 42 affixed within the top end of hollow lower stem portion 18 near its upper end. Support member 38 includes a circular hinge base 44 at an upper end of, and somewhat larger in diameter than, lower support stem 18. The outer surface 46 of hinge base 42 is threaded.

A pair of support members 48 and 49 project upwardly from the top surface of circular hinge base 44. The outer surfaces of members 48 and 49 are accurate, following the contour of hinge base 44, and are separated by a slot 50 defined by opposing parallel walls 52 for receiving a hinge plate 54. A pivot pin 56 is mounted in support members 48 and 50 and extends across slot 52.

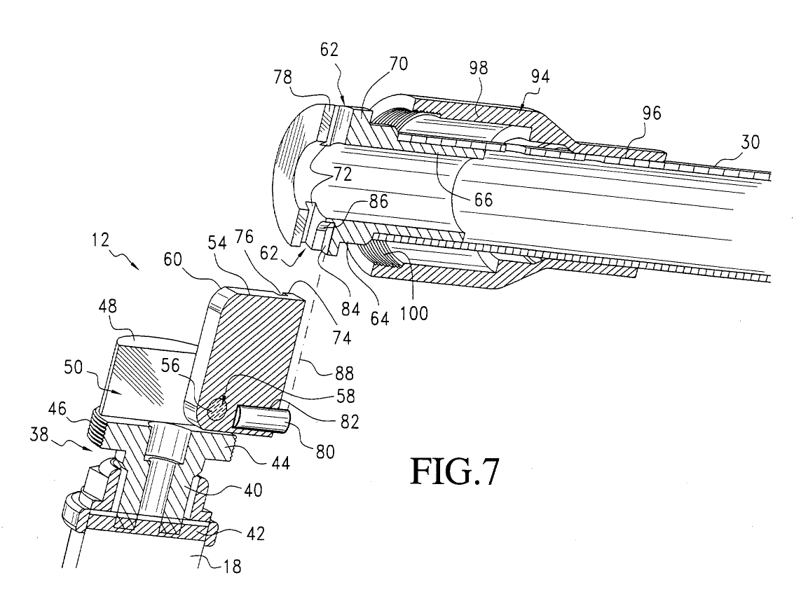

Hinge plate 54 has a bearing hole 56 (see FIG. 7) about a pivot pin 58. Thus, hinge plate 54 pivots about pivot pin 58 and moves in slot 52. Since hinge plate 54 has parallel sides 60 which are parallel to opposing walls 52 of slot 50, it is guided and supported by opposing walls 52 as it pivots in slot 50.

So that upper stem portion 30 may be hinged relative to lower stem portion 18, it is necessary to couple hinge plate 54 to upper stem portion 30. This is accomplished by providing a slot 62 in a connector member 64 mounted on the lower end of upper stem portion 30, as shown in FIGS. 6, 7, and 8. Connector member 64 includes an end 66, which fits snugly within the lower end of upper stem portion 30 and is properly positioned relative to upper stem position 30 by a shoulder 68, which abuts the end of stem portion 30. Connecter member 64 is further widened to provide a connecter collar 70 with wider side walls through which to form slot 62. It will be observed that slot 62 has two sections through opposite sides of connecter collar 70.

Slot 62 is provided with guide grooves 72 on each side of slot 62, which are shaped to receive complementary rails 74 formed in opposite walls 60 of hinge plate 54. Rails 74 are formed by groves 76 formed on opposite walls 60 of hinge plate 54. These grooves 76 receive complementary rails 78 formed in slot 62 at the end of connector member 64.

When hinge plate 54 is slid into slot 62, guide rail 74 engages in guide groove 72; and guide rail 78 engages guide slot 76. The result is a solid connection between hinge plate 54 and slot 62.

In order to properly engage hinge plate 54 with slot 62, it is necessary that the hinge plate and slot be aligned. It is also necessary that hinge plate 54 be slid the proper distance to maximize the engagement of the hinge plate and slot. To these ends, an alignment and stop pin 80 seated in a bore 82 provided in hinge plate 54. A guide wall 84 is also formed in slot 62, and a stop wall 86 is formed at the end of guide wall 84.

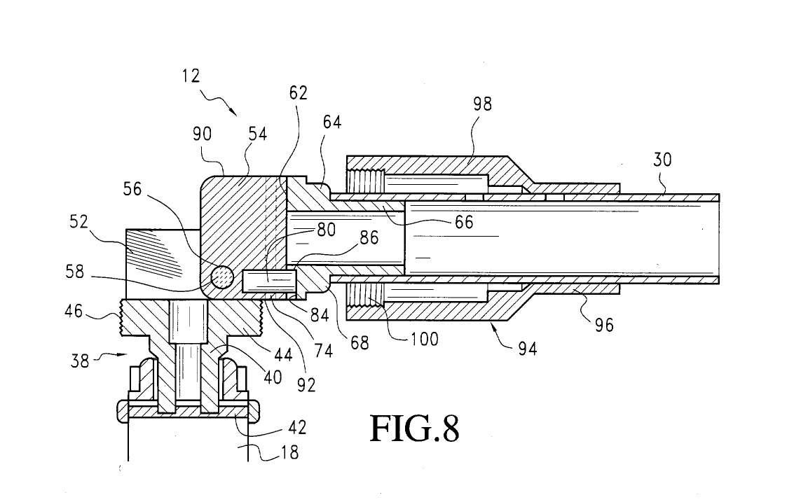

As seen in FIGS. 7 and 8, alignment and stop pin 80 protrudes to a position defined by line 88. When hinge plate 54 is slid into slot 62, the end of pin 80 engages guide wall 84 keeping hinge plate 54 in alignment as it engages the upper portion (as seen in FIG. 8) of slot 62. Also, when alignment and stop pin 80 engages with stop wall 86, further sliding of hinge plate 54 in slot 62 is prevented. As seen in FIG. 8, with pin engaged with stop wall 86, the upper surface 90 and lower surface 92 of hinge plate 54 are in alignment with the outer surfaces of connector member 64. There is therefore maximum engagement between hinge plate 54 and slot 62.

A hinge plate cover sleeve 94 includes a narrow end portion 96 which is sized to slide along the outer surface of upper stem portion 30. Sleeve 94 also has a widened portion 98, which is spaced from the outer surface of upper stem portion 30. At the lower end of sleeve 94, the inner surface is provided with internal threads 100, which are sized and adapted to thread with external threads 46 on hinge base 44.

Hinge cover sleeve 94 may be placed in three positions as determined by the operation of detent buttons 34 and 36, both of which are spring-biased to a projected position. When both detent buttons project from upper stem portion 30, as seen in FIG. 4, with detent button 34 abutting the upper end 102 of hinge cover sleeve 94, sleeve 94 completely covers engaged hinge components 54 and 64, keeping stem portions 18 and 30 aligned and erect. This is the position required for normal operation of the scooter in the configuration shown in FIGS. 1 and 2. Sleeve 94 is rotated with interior threads 100 engaged with exterior threads 46 on hinge base 44. Sleeve 94 is screwed down tightly to eliminate any rattle. If parts wear, sleeve 94 can be tightened further so that there is still no rattle.

When it is desired to fold down upper stem portion 30 or to disassemble hinge assembly 12, sleeve 94 is unscrewed from exterior threads 46 on hinge base 44, detent button 34 is depressed and covered by narrow end 96 of sleeve 94 as it is slid to the second position shown in FIG. 5 where detent button 36 abuts the upper end of sleeve 94. With sleeve 94 in this position, widened portion 98 of sleeve 94 partially covers engaged hinge components 54 and 64 to block disassembly, but hinge plate 54 is free to rotate allowing upper stem portion 30 to be folded down to a substantially horizontal position as shown in FIGS. 3 and 6. This is the configuration preferred for storage of the scooter.

When disassembly of hinge assembly 12 is desired, detent button 36 is depressed, and sleeve 94 is slid to the position shown in FIG. 7. Sleeve 94 is completely clear of hinge components 54 and 64. Hinge plate 54 can now be slid from engagement with connector member 64 to the position shown in FIG. 7.

Hinge assembly 12 can be reassembled by reversing these steps. Hinge plate 54 is engaged with slot 62. With the help of alignment and stop pin 80, hinge plate 54 is slid into slot 32 until it is fully engaged with connecter member 64, as shown in FIGS. 6 and 8. Sleeve 94 is then slid to the position shown in FIG. 6. Detent button 36, which is now uncovered, is biased to its projected position to block sleeve 94 from sliding to a position in which hinge assembly 12 can be inadvertently disassembled. Upper stem portion 30 is hinged back to a position in alignment with lower stem section 18, as shown in FIG. 5. Sleeve 94 is then slid down to engage interior threads 100 with exterior threads 46. Sleeve 94 is then screwed down tightly to eliminate rattle. Detent button 34 is now uncovered and biased to its projected position to keep sleeve 94 from sliding from the position shown in FIG. 4.

Although the invention has been explained in relation to a preferred scooter embodiment, it is to be understood that the invention can be used in other vehicles having a vertical stem, such as bicycles and the like, and that other modifications and variations can be made without departing from the scope of the invention as claimed.

What is claimed is:

1. A vehicle stem hinge assembly comprising:
a first stem portion;
a second stem portion;
hinge means connecting said first stem portion to said second stem portion, said hinge means comprising a hinge plate pivoted to one of said stem portions at a pivot point near an end thereof and a slot formed on an end of the other stem portion, said hinge plate being receivable in said slot, said hinge plate, when received in said slot, being pivotable to bring said first stem portion in alignment with said second stem portion; and
a hinge cover sleeve slidable on one of said stem portions and being slidable to a first position over said hinge means when said first and second stem portions are aligned to prevent said first stem portion and second stem portion from being moved out of alignment.

2. A vehicle stem hinge assembly of claim 1 wherein said second stem portion comprises a retractable stop member projecting from said second stem portion at a point beyond an end of said hinge cover sleeve when it is slid over said hinge means to prevent, when projected, said hinge cover sleeve from sliding from said first position and, when retracted, permitting said sleeve to be slid to a second position uncovering said hinge means to permit said second stem section to be folded relative to said first stem section, said hinge cover sleeve in said second position covering a portion of said hinge plate to prevent disassembly of said hinge means.

3. A vehicle stem hinge assembly of claim 2, wherein said second stem portion comprises a second retractable stop member projecting from said second stem portion at a point beyond said end of said hinge cover sleeve when it is in its second position, said second retractable stop member, when retracted, permitting said hinge cover sleeve to be slid over said second retractable stop member and uncovering said hinge plate to permit said hinge plate to be removed from said slot to disassemble said hinge means.

4. A vehicle stem hinge assembly of claim 1 wherein said hinge cover sleeve comprises a second end, said second end comprising screw threads on an internal surface, and wherein said first stem position has external screw threads threadable with said internal screw threads and positioned at a second point further from said end of said first stem portion than said pivot point, said internal screw threads of said hinge cover sleeve, when said hinge cover sleeve is in said first position being threadable with said external screw threads to secure said hinge cover sleeve over said hinge assembly to prevent hinging of said first and second stem sections.

5. A vehicle stem hinge assembly of claim 1, wherein said hinge plate comprises an alignment and stop pin projecting from one side thereof, said slot being shaped to provide a guide path and a stop wall for said alignment and stop pin, whereby said hinge plate is positioned in said slot with said pin being guided along said guide path to position said hinge plate properly in said slot and to limit the movement of said hinge plate into said slot.

6. A vehicle stem hinge assembly of claim 5, wherein said slot comprises opposing walls with opposing guide grooves provided in said opposing walls and said hinge plate has opposite walls with opposing grooves, forming guide rails, said guide rails being engaged with said guide grooves in said slot, whereby said guide rails are engaged with said guide grooves as said hinge plate is slid into said slot until said stop pin engages said stop wall to limit the extent of said sliding of said hinge plate along said guide grooves in said slot.

7. A vehicle stem hinge assembly of claim 1, wherein said first stem portion comprises a hinge slot with opposing walls, a pivot pin extending between said walls, and a hinge plate pivoted on said pivot pin between said opposing walls.

8. A vehicle stem hinge assembly of claim 1, wherein said vehicle is a scooter with a vertical handlebar stem, wherein said first and second stem portions comprise lower and upper portions of said vertical handlebar stem.

9. A vehicle having a vertical handlebar stem assembly, said assembly comprising:
a lower stem portion;
an upper stem portion;
hinge means for hinging said upper stem portion to said lower stem portion;
said hinge means, when assembled, comprising a hinge plate hinged about a pivot member near an end of one of said stem portions, a hinge plate receiving slot formed in an end of the other stem portion, said hinge plate having a free edge in sliding engagement with said receiving slot, whereby said other stem portion is hinged with said hinge plate about said pivot member to bring said other stem portion to a position in alignment with said one stem portion or to a folded position at an angle to said one stem portion;
a hinge cover sleeve having a first position locking said lower and upper stem portions in aligned relationship, a second position permitting said hinge assembly to fold said upper stem portion to a substantially horizontal position while preventing said hinge plate from sliding from said slot, and a third position permitting said hinge plate to slide out of said slot to separate said lower and upper stem sections to disassemble said hinge means.

10. A vehicle of claim 9, wherein said hinge plate comprises an alignment and stop pin projecting from said free edge and said hinge plate receiving slot comprises a guide wall parallel to said free edge and a stop wall, whereby, as said hinge plate is slid into said receiving slot, said alignment and stop pin rides in engagement with said guide wall to position said hinge plate properly in said receiving slot and when said alignment and stop in engages said stop wall, said hinge plate is blocked from sliding any further in said receiving slot.

11. A vehicle of claim 9, wherein said receiving slot is formed between spaced opposing walls, said walls having opposing guide grooves, and wherein said hinge plate has rail forming grooves on opposite sides, said rail forming grooves being parallel to said free edge and forming guide rails between said rail forming grooves and said free edge, said guide rails being received in said guide grooves when said hinge plate is slid into said receiving slot.

12. A vehicle of claim 9, wherein said hinge cover sleeve comprises thread means for tightly fixing said hinge cover sleeve to said lower stem portion.

13. A vehicle of claim 12, wherein said thread means comprises internal thread means adjacent one end thereof and said lower stem portion has external threads below said hinge means, said internal thread means being threadable with said external threads.
